(19) United States
(12) Patent Application Publication
(10) Pub. No.: US 2013/0177777 A1
(43) Pub. Date: Jul. 11, 2013

(54) COATED ARTICLE AND METHOD FOR MAKING SAME

(71) Applicant: DA-HUA CAO, Shenzhen City (CN)

(72) Inventor: DA-HUA CAO, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/603,507

(22) Filed: Sep. 5, 2012

(30) Foreign Application Priority Data
Jan. 11, 2012 (CN) 201210007268.9

(51) Int. Cl. B32B 15/01; B05D 1/18

(52) U.S. Cl. 428/565; 427/438

(57) ABSTRACT

A coated article includes a metal substrate and an abrasion-resisting layer formed on a surface of the metal substrate. The abrasion-resisting layer consists essentially of amorphous phosphorus-nickel alloy with polytetrafluoroethylene particles and tungsten carbide particles dispersed therein. A method for making the present coated article is also described.

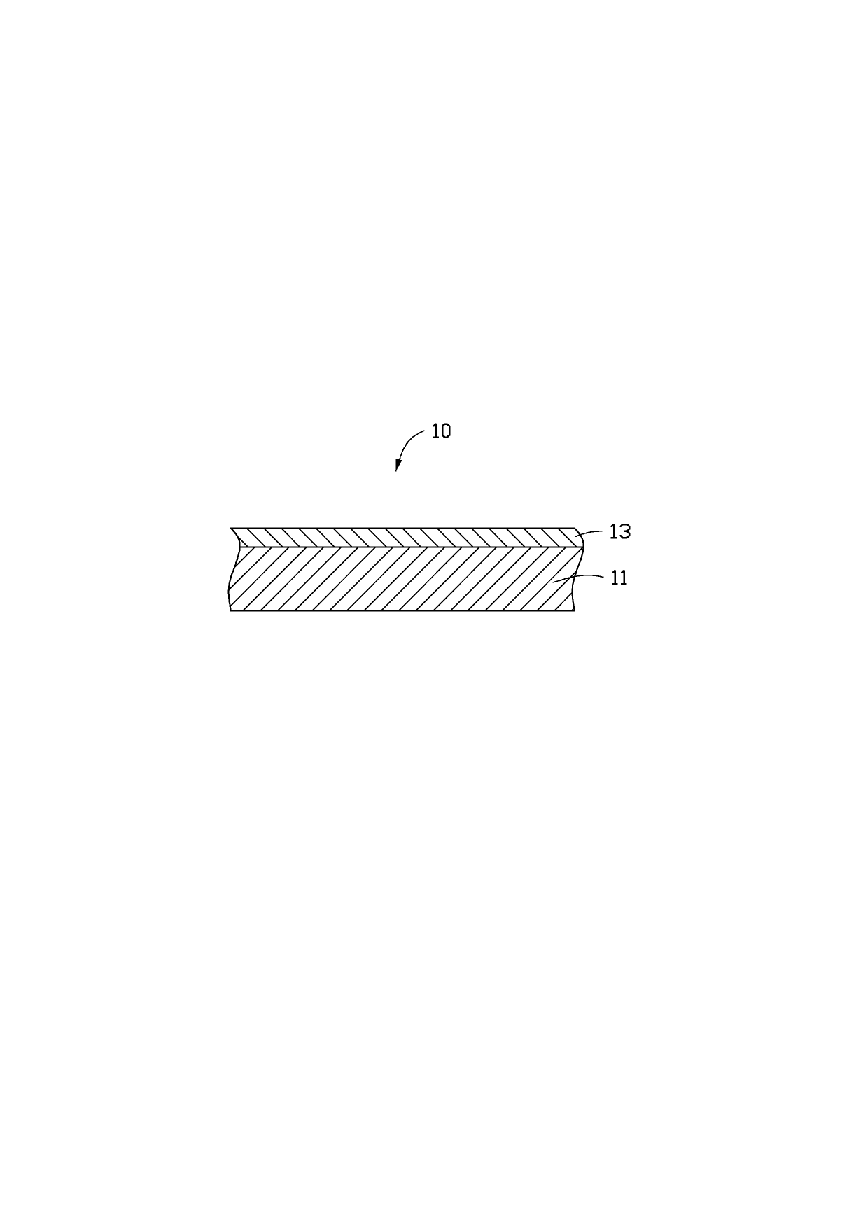

### BACKGROUND

1. Technical Field

The present disclosure relates to a coated article having a good abrasion resistance and a method for making the coated article.

2. Description of Related Art

Sliding members (such as sliding rail) of slide phones and hinges of clamshell phones undergo many and repeated use cycles. So, the sliding members and hinges are easily abraded, and thus shorten the service life of the sliding members and hinges.

Therefore, there is room for improvement within the art.

### BRIEF DESCRIPTION OF THE DRAWING

Many aspects of the disclosure can be better understood with reference to the drawing. The components in the drawing are not necessarily drawn to scale, the emphasis instead being placed upon clearly illustrating the principles of the disclosure. Moreover, in the drawings like reference numerals designate corresponding parts throughout the views.

The FIGURE is a schematic cross-sectional view of an exemplary embodiment of a coated article.

### DETAILED DESCRIPTION

The FIGURE shows an exemplary coated article 10 including a metal substrate 11 and an abrasion-resisting layer 13 directly formed on a surface of the metal substrate 11. As used in this disclosure, “directly” means a surface of one layer is in contact with a surface of the other layer.

The metal substrate 11 may be made of iron-based alloy, such as carbon steel and stainless steel. The metal substrate can also be made of aluminum alloy, magnesium alloy, or titanium alloy.

The abrasion-resisting layer 13 consists essentially of amorphous phosphorus-nickel alloy having polytetrafluoroethylene (PTFE) particles and tungsten carbide particles dispersed therein. The PTFE particles may have an average particle diameter of about 30 nanometers (nm) to about 100 nm. The tungsten carbide particles may have an average particle diameter of about 50 nm to about 100 nm. Within the abrasion-resisting layer 13, the PTFE particles have a mass percentage of about 6% to about 20%; the tungsten carbide particles have a mass percentage of about 3% to about 10%. The abrasion-resisting layer 13 may be formed by electroless plating and may have a thickness of about 5 micrometers (μm) to about 15 μm.

The coated article 10 can be a sliding rail or a hinge for electronic devices.

The abrasion-resisting layer 13 of the coated article 10 mainly comprises phosphorus-nickel alloy providing a good erosion resistance and a good abrasion resistance. The abrasion-resisting layer 13 is further dispersed with PTFE particles and tungsten carbide particles. The PTFE particles have good self lubricating property, reducing the friction coefficient of the abrasion-resisting layer 13. The tungsten carbide particles are high hardness material, improving the abrasion resistance of the abrasion-resisting layer 13.

The process for making the coated article 10 includes providing a metal substrate 11 and forming the abrasion-resisting layer 13 on the metal substrate 11 by electroless plating.

Electroless plating the abrasion-resisting layer 13 uses an aqueous solution as the plating bath. The plating bath contains about 20 g/L-25 g/L NiSO₄.6H₂O, about 20 g/L-25 g/L NaH₂PO₂.H₂O, about 4 g/L-8 g/L PTFE particles, about 1 g/L-3 g/L tungsten carbide particles, about 10 g/L-15 g/L sodium acetate , about 10 g/L-15 g/L citric acid, about 15 g/L-20 g/L lactic acid, about 0.05 g/L-0.3 g/L sodium fluoride, and a cationic fluorocarbon surfactant. The cationic fluorocarbon surfactant may be a trade name surfactant fluorocarbon surfactant FC-4 (structural formula:

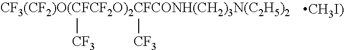

at a concentration of about 0.05 g/L-0.3 g/L. The PTFE particles and the tungsten carbide particles are uniformly dispersed and suspended in the plating bath. The PTFE particles may have an average particle diameter of about 30 nm to about 100 nm. The tungsten carbide particles may have an average particle diameter of about 50 nm to about 100 nm. The plating bath may have a pH value of about 4.0 to about 5.4 and is maintained at a liquid temperature of about 88° C. to about 92° C. during the electroless plating. The electroless plating may take about 40 minutes (min) to about 90 min. The PTFE particles, tungsten carbide particles, phosphorus and nickel contained in the plating bath are deposited onto the surface of the metal substrate 11 to form the abrasion-resisting layer 13.

The abrasion-resisting layer 13 has a friction coefficient of about 0.18 to about 0.25 and has a vickers hardness of about 800 HV (25 gf) to about 910 HV (25 gf). However, an electroless plated phosphorus-nickel alloy containing no PTFE particles or tungsten carbide particles with the same thickness has a friction coefficient of about 0.6 to about 0.7 and has a vickers hardness of about 500 HV (25 gf) to about 600 HV (25 gf).

In other embodiments, the process for making the coated article 10 may further include pretreating the metal substrate 11 before electroless plating the abrasion-resisting layer 13. The pretreatment may include:

a) degreasing: A commercial metal degreasing agent may be used. For example, the metal substrate 11 can be degreased using a solution containing about 30 g/L Na₃PO₄, about 25 g/L Na₂CO₃, and about 8 g/L Na₂SiO₃ and at a liquid temperature of about 70° C. to about 75° C. The degreasing may take about 2 min to about 5 min.

b) a first activation: The metal substrate 11 may be immersed in a first activating solution prepared by hydrochloric acid and water at a ratio of about 1:4 by volume for about 6 seconds (s) to about 30 s. The first activating solution may be maintained at room temperature.

c) acid etching: The metal substrate 11 may be immersed in an etching agent comprising of nitric acid and water at a ratio of about 1:1 by volume for about 3 s to about 5 s. The etching agent may be maintained at room temperature.

d) a second activation: The substrate 11 may be immersed in a second activating solution containing 10% (by weight) sulphuric acid for about 50 s to about 60 s. The second activating solution may be maintained at room temperature.

The substrate 11 may be cleaned by deionized water after each of the a), b), c), and d) steps.

### EXAMPLES

Experimental examples of the present disclosure are described as follows.

### Example 1

1. A carbon steel substrate 11 was pretreated according to the following steps.

a) degreasing: The substrate 11 was immersed in a degreasing agent containing 30 g/L Na₃PO₄, 25 g/L Na₂CO₃, and 8 g/L Na₂SiO₃ for about 2 minutes. The degreasing agent was maintained at a liquid temperature of about 70° C.-75° C.

b) a first activation: The substrate 11 was immersed in a first activating solution prepared by mixing hydrochloric acid and water at a ratio of about 1:4 by volume for about 10 s.

c) acid etching: The substrate 11 was immersed in an etching agent prepared by mixing nitric acid and water at a ratio of about 1:1 by volume for about 3 s.

d) a second activation: The substrate 11 was immersed in a second activating solution containing 10% (by weight) sulphuric acid for about 50 s.

2. electroless plating the abrasion-resisting layer 13 on the substrate 11: The plating bath for electroless plating the abrasion-resisting layer 13 contained about 20 g/L NiSO₄.6H₂O, about 20 g/L NaH₂PO₂.H₂O, about 4 g/L PTFE particles, about 1 g/L tungsten carbide particles, about 10 g/L sodium acetate , about 10 g/L citric acid, about 15 g/L lactic acid, about 0.05 g/L sodium fluoride, and about 0.05 g/L fluorocarbon surfactant FC-4. The PTFE particles had an average particle diameter of about 30 nm to about 100 nm. The tungsten carbide particles had an average particle diameter of about 50 nm to about 100 nm. The plating bath had a pH value of about 4.0 and maintained a liquid temperature of about 90° C. during the electroless plating. The electroless plating took about 40 min. The resulting abrasion-resisting layer 13 was tested to have a friction coefficient of about 0.25 and a vickers hardness of about 800 HV (25 gf).

### Example 2

1. An aluminum alloy substrate 11 was pretreated according to the following steps.

a) degreasing: The substrate 11 was immersed in a degreasing agent containing 30 g/L Na₃PO₄, 25 g/L Na₂CO₃, and 8 g/L Na₂SiO₃ for about 4 minutes. The degreasing agent was maintained at a liquid temperature of about 70° C.-75° C.

b) a first activation: The substrate 11 was immersed in a first activating solution prepared by mixing hydrochloric acid and water at a ratio of about 1:4 by volume for about 10 s.

c) acid etching: The substrate 11 was immersed in an etching agent prepared by mixing nitric acid and water at a ratio of about 1:1 by volume for about 5 s.

d) a second activation: The substrate 11 was immersed in a second activating solution containing 10% (by weight) sulphuric acid for about 60 s.

2. electroless plating the abrasion-resisting layer 13 on the substrate 11: The plating bath for electroless plating the abrasion-resisting layer 13 contained about 23 g/L NiSO₄.6H₂O, about 23 g/L NaH₂PO₂.H₂O, about 6 g/L PTFE particles, about 2 g/L tungsten carbide particles, about 12 g/L sodium acetate , about 12 g/L citric acid, about 18 g/L lactic acid, about 0.1 g/L sodium fluoride, and about 0.1 g/L fluorocarbon surfactant FC-4. The PTFE particles had an average particle diameter of about 30 nm to about 100 nm. The tungsten carbide particles had an average particle diameter of about 50 nm to about 100 nm. The plating bath had a pH value of about 4.0 and maintained a liquid temperature of about 98° C. during the electroless plating. The electroless plating took about 60 min. The resulting abrasion-resisting layer 13 was tested to have a friction coefficient of about 0.2 and a vickers hardness of about 850 HV (25 gf).

### Example 3

1. An aluminum alloy substrate 11 was pretreated according to the following steps.

a) degreasing: The substrate 11 was immersed in a degreasing agent containing 30 g/L Na₃PO₄, 25 g/L Na₂CO₃, and 8 g/L Na₂SiO₃ for about 5 minutes. The degreasing agent was maintained at a liquid temperature of about 70° C.-75° C.

b) a first activation: The substrate 11 was immersed in a first activating solution prepared by mixing hydrochloric acid and water at a ratio of about 1:4 by volume for about 15 s.

c) acid etching: The substrate 11 was immersed in an etching agent prepared by mixing nitric acid and water at a ratio of about 1:1 by volume for about 4 s.

d) a second activation: The substrate 11 was immersed in a second activating solution containing 10% (by weight) sulphuric acid for about 55 s.

2. electroless plating the abrasion-resisting layer 13 on the substrate 11: The plating bath for electroless plating the abrasion-resisting layer 13 contained about 25 g/L NiSO₄.6H₂O, about 25 g/L NaH₂PO₂.H₂O, about 8 g/L PTFE particles, about 3 g/L tungsten carbide particles, about 15 g/L sodium acetate , about 15 g/L citric acid, about 20 g/L lactic acid, about 0.3 g/L sodium fluoride, and about 0.3 g/L fluorocarbon surfactant FC-4. The PTFE particles had an average particle diameter of about 30 nm to about 100 nm. The tungsten carbide particles had an average particle diameter of about 50 nm to about 100 nm. The plating bath had a pH value of about 4.0 and maintained a liquid temperature of about 92° C. during the electroless plating. The electroless plating took about 90 min. The resulting abrasion-resisting layer 13 was tested to have a friction coefficient of about 0.18 and a vickers hardness of about 910 HV (25 gf).

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A coated article, comprising:
a metal substrate; and
an abrasion-resisting layer formed on a surface of the metal substrate, the abrasion-resisting layer consisting essentially of amorphous phosphorus-nickel alloy with polytetrafluoroethylene particles and tungsten carbide particles dispersed therein.

2. The coated article as claimed in claim 1, wherein the polytetrafluoroethylene particles have an average particle diameter of about 30 nm to about 100 nm.

3. The coated article as claimed in claim 1, wherein within the abrasion-resisting layer, the polytetrafluoroethylene particles have a mass percentage of about 6% to about 20%.

4. The coated article as claimed in claim 1, wherein the tungsten carbide particles have an average particle diameter of about 50 nm to about 100 nm.

5. The coated article as claimed in claim 1, wherein within the abrasion-resisting layer, the tungsten carbide particles have a mass percentage of about 3% to about 10%.

6. The coated article as claimed in claim 1, wherein the abrasion-resisting layer has a thickness of about 5 μm to about 15 μm.

7. The coated article as claimed in claim 1, wherein the metal substrate is made of iron-based alloy.

8. The coated article as claimed in claim 1, wherein the metal substrate is made of one material selected from the group consisting of aluminum alloy, magnesium alloy, and titanium alloy.

9. A method for making a coated article, comprising:
providing a metal substrate; and
forming an abrasion-resisting layer on the metal substrate by electroless plating, the abrasion-resisting layer consisting essentially of amorphous phosphorus-nickel alloy with polytetrafluoroethylene particles and tungsten carbide particles dispersed therein.

10. The method as claimed in claim 9, wherein electroless plating the abrasion-resisting layer uses a plating bath containing about 20 g/L-25 g/L NiSO₄.6H₂O, about 20 g/L-25 g/L NaH₂PO₂.H₂O, about 4 g/L-8 g/L polytetrafluoroethylene particles, about 1 g/L-3 g/L tungsten carbide particles, about 10 g/L-15 g/L sodium acetate, about 10 g/L-15 g/L citric acid, about 15 g/L-20 g/L lactic acid, about 0.05 g/L-0.3 g/L sodium fluoride, and a cationic fluorocarbon surfactant; the plating bath has a pH value of about 4.0 to about 5.4 and is maintained at a liquid temperature of about 88° C. to about 92° C. during the electroless plating.

11. The method as claimed in claim 10, wherein the cationic fluorocarbon surfactant is a trade name surfactant fluorocarbon surfactant FC-4 at a concentration of about 0.05 g/L-0.3 g/L.

12. The method as claimed in claim 10, wherein the electroless plating takes about 40 min to about 90 min.

13. The method as claimed in claim 10, wherein the polytetrafluoroethylene particles have an average particle diameter of about 30 nm to about 100 nm.

14. The method as claimed in claim 10, wherein the tungsten carbide particles have an average particle diameter of about 50 nm to about 100 nm.

15. The method as claimed in claim 1, wherein the metal substrate is made of one material selected from the group consisting of iron-based alloy, aluminum alloy, magnesium alloy, and titanium alloy.
